(19) United States
(12) Patent Application Publication
(10) Pub. No.: US 2024/0420092 A1
(43) Pub. Date: Dec. 19, 2024

(54) A METHOD FOR SCHEDULING MUTUAL MEETINGS, INCLUDING MEMBERS AND NON-MEMBERS OF A SOCIAL NETWORKING SERVICE

(71) Applicant: WEMET.COM CO.,Ltd, Seoul (KR)

(72) Inventor: Young Hyun CHO, Seoul (KR)

(21) Appl. No.: 18/703,481

(22) PCT Filed: Oct. 21, 2022
(86) PCT No.: PCT/KR2022/016116

§ 371 Date: Apr. 22, 2024

(30) Foreign Application Priority Data
Oct. 22, 2021 (KR) 10-2021-0141472

(51) Int. Cl. G06Q 10/1093; G06Q 50/00

(52) U.S. Cl. CPC G06Q 10/1095; G06Q 50/01

(57) ABSTRACT

The present disclosure relates to a method for scheduling mutual meetings in a social networking service, including members and non-members, the method for scheduling meetings according to the present disclosure is characterized in that it is possible to schedule meetings between members of a social networking service and between members and non-members of a social networking service in an efficient and simple way.

### TECHNICAL FIELD

The present invention relates to a method for scheduling a meeting between a member and a non-member of a social networking service, and more particularly to a method for scheduling a mutual meeting between members of a social networking service and between a member and a non-member of a social networking service.

### BACKGROUND ART

Typically, before attending a conference for networking purposes, an individual will schedule a meeting with the participants attending the conference in advance by setting a meeting time and meeting location. In order to schedule these meetings, a list of attendees is needed in advance and will need to send an email to the attendees to see if they are available, where they will meet, and when they will meet. Meetings that are scheduled will be recorded in a separate spreadsheet as a meeting list, and then will be referred to during the days of the conference.

However, when scheduling meetings in this way, there have been problems such as exchanging emails every time, transferring the confirmed meeting to a separate spreadsheet, and mistakes in the transfer, which can cause the meeting to be canceled on the day of the meeting.

### PRIOR ART

### Patent Citation

(Patent 0001) Patent Publication Gazette 10-2017-0084100)

### DISCLOSURE OF THE INVENTION

### Technical Problem

Accordingly, it is an object of the present disclosure to solve these prior art problems by providing a method for scheduling meetings with each other, including members and non-members, of a social networking service that allows for a simple way to schedule meetings before attending a conference.

The present disclosure also provides a method for scheduling mutual meetings between members and non-members of a particular social network service, including members and non-members of the social network service, to efficiently schedule meeting appointments.

### Technical Solution

The object of the present disclosure relates to a method for scheduling mutual meetings, including members and non-members, of a social networking service, implemented on the web and comprising a meeting proposal preparation step wherein a meeting proponent enters meeting proposal information on a meeting proposal screen, the meeting proposal information including at least one of meeting party, meeting party's company, meeting time, meeting place, and meeting party's e-mail address; a meeting schedule preparation step preparing a meeting schedule screen for outputting the meeting proposal information or inputting new information for the meeting proposal information; a meeting information database preparation step storing the meeting proposal screen or inputted value inputted through the meeting schedule screen in meeting information database; a first action step transferring a link of the meeting schedule screen to meeting party for scheduling a meeting; a second action step storing meeting information inputted by the meeting party through information shown on the meeting proposal screen accessed through the link transferred through the first action step; a third action step transferring a link of the meeting schedule screen including the inputted meeting proposal information in the meeting proposal preparation step; and a fourth action step storing meeting confirmation information or meeting change information in the meeting information database, the meeting confirmation information of the meeting change information inputted by the meeting party accessed through the link transferred through the third action step, wherein if the meeting party is a member of the social networking service, processes any one of the first action step, the second action step, the third action step, and the fourth action step through member notification and e-mail, and wherein if the meeting party is not a member of the social networking service, processes any one of the first action step, the second action step, the third action step, and the fourth action step through e-mail.

Preferably, an example of the present disclosure can include a member verification step to verify whether the meeting party is a member or a non-member of the social networking service based on information inputted by the meeting party before the meeting proposal preparation step and preparing a member meeting proposal screen and a non-member meeting proposal screen according to the member verification step.

Additionally, an example of the present disclosure can include a meeting information output step outputting meeting information from the databased storing the meeting information.

### Advantageous Effects

The present disclosure can provide for scheduling mutual meetings, including members and non-members of a social networking service that enables scheduling a meeting in a simple manner.

Additionally, a method is provided for scheduling mutual meetings, including between members and non-members of a particular site, in a social networking service that allows scheduling meetings between members and non-members.

### BRIEF DESCRIPTION OF THE DRAWINGS

FIG. 1 is a schematic diagram illustrating a method for scheduling a meeting according to the present disclosure.

FIG. 2 is a schematic diagram illustrating a meeting proposal screen for members.

FIG. 3 is a schematic illustration of a meeting proposal screen for non-members.

FIG. 4 is a schematic illustration of a meeting scheduling screen.

FIG. 5 is a schematic representation of a meeting list screen.

### MODE FOR CARRYING OUT THE INVENTION

For the purposes of the following description, in various embodiments, components having the same configuration will be described using the same symbols to refer to the representative first embodiment, and other embodiments will describe configurations that differ from the first embodiment.

With reference to the accompanying drawings, a method for scheduling mutual meetings, including members and non-members of a social networking service according to the first embodiment of the present disclosure will be described in detail.

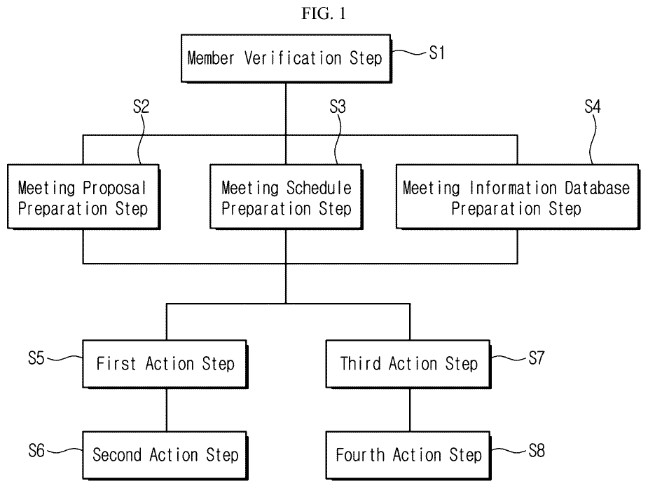

FIG. 1 is a flow diagram illustrating a method of scheduling a meeting according to the present invention. As shown in the figure, a method of scheduling a mutual meeting including a member and a non-member of a social networking service according to the present disclosure includes a membership verification step (S1) to verify whether the meeting partner is a member, a meeting proposal preparation step (S2) in which a meeting proponent prepares a meeting proposal by entering meeting information to the meeting party, a meeting schedule preparation step (S3) in which a meeting schedule screen is prepared in which the meeting information entered in the meeting proposal preparation step (S2) is outputted, and a meeting information database preparation step (S4) in which the meeting information can be stored, The first action step (S5), which transmits the link to the meeting schedule screen to the meeting party, and the second action step (S6), which transmits the meeting information entered by the meeting party on the meeting schedule screen outputted through the link transmitted in the first operation step (S5) back to the meeting proponent, a third action step (S7) in which the link of the meeting schedule screen outputting the meeting information entered in the meeting proposal preparation step (S2) is transmitted to the meeting party, and a fourth action step (S8) in which the meeting confirmation information or the changed meeting information is entered by the meeting party on the meeting schedule screen transmitted in the third action step (S7) and transmitted to the meeting proponent.

In the membership verification step (S1), the meeting party of the meeting is checked whether the meeting party is a member of the social networking service. If the meeting party is a member of the social networking service, the meeting proposal is sent and confirmed at the later stage using the site's notification function and e-mail, and if the meeting party is not a member of the social networking service, the meeting proposal is sent and confirmed at the later stage via e-mail.

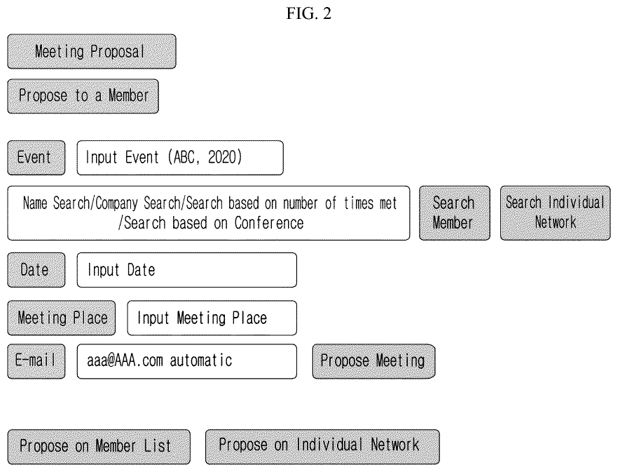

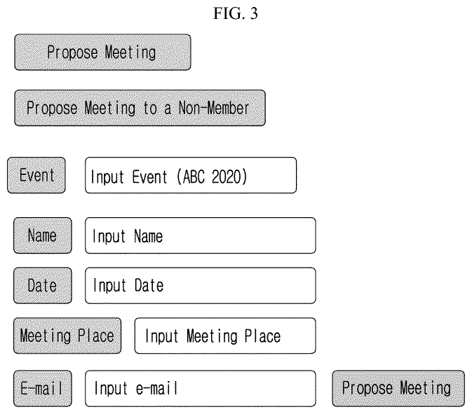

In the meeting proposal preparation step (S2), a meeting proposal screen is prepared to enter meeting information such as the identity of the meeting party, the meeting party's company, the meeting time, and the meeting location. FIG. 2 is a schematic diagram of the meeting proposal screen for members, and FIG. 3 is a meeting proposal screen for non-members. If the meeting party of the meeting is a member, the name, company, email, etc. of the meeting party is automatically entered by loading the information from the existing membership information, and if the meeting party of the meeting is a non-member, the meeting proponent enters the meeting information manually. The meeting information entered in the meeting proposal preparation step (S2) is entered and saved in the meeting information database of the meeting proponent.

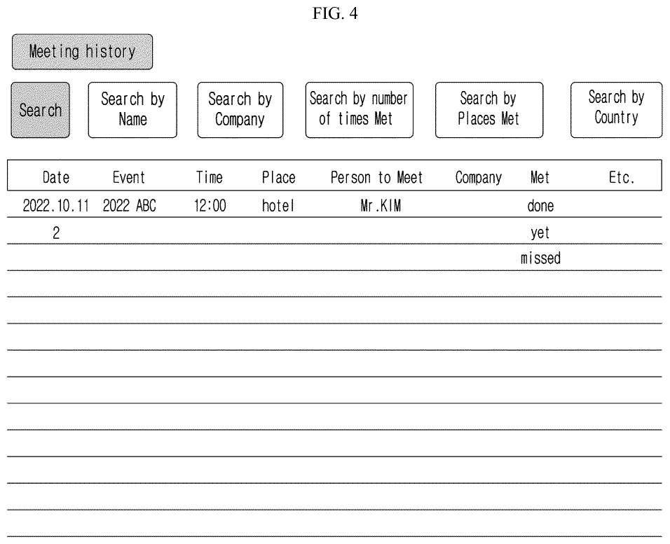

In the meeting schedule preparation stage (S3), a meeting schedule screen is prepared where the meeting information entered in the meeting proposal preparation stage (S2) is displayed or new meeting information can be entered. FIG. 4 is a schematic diagram illustrating a meeting schedule screen. As shown in the figure, if the meeting information is entered by the meeting proponent, the entered meeting information is outputted on the meeting schedule screen outputted to the meeting party, and if the meeting proponent does not enter the meeting information, the meeting schedule screen is outputted without any information. On the other hand, new meeting information can be entered by the meeting party on the meeting schedule screen outputted to the meeting party. That is, the meeting party can change the meeting information entered by the meeting proponent or enter new meeting information if no meeting information is entered.

In the meeting database preparation step (S4), the meeting information entered by the meeting proponent or the meeting party to the meeting is entered. At this point, the most recent meeting information is entered into the database.

In the first action step (S5), the meeting proponent transmits a link containing the information on the meeting schedule screen described above to the meeting party. At this time, if the meeting party is a member of the social networking service, the link is transmitted simultaneously to the member notification and e-mail using the member information, and if the meeting party is a non-member, the link is transmitted only to the inputted e-mail.

In the second action step (S6), the meeting schedule screen is outputted to the meeting party through the link received from the meeting proponent, and the meeting information including the meeting place and meeting time is entered by the meeting party, and the meeting information is sent back to the meeting proponent. In other words, the meeting proponent does not enter the meeting information, but just checks whether the meeting party wants to meet, and if the meeting party wants to meet, the meeting party enters the desired meeting time and meeting place, and the entered meeting information is sent back. At this time, the replied meeting information is stored in the meeting information database.

In the third action step (S7), the meeting schedule screen with meeting information entered by the meeting proponent is transmitted to the meeting party of the meeting. In other words, in the first action step, a link without meeting information was transmitted to the meeting party of the meeting, but in the third action step, a link to the meeting schedule screen with meeting information is delivered to the meeting party of the meeting.

In the fourth action step (S8), the meeting party can confirm or change the meeting schedule on the meeting schedule screen transmitted by the third action step (S7). In other words, if the meeting party accepts the meeting time and meeting place proposed by the meeting proponent, the meeting confirmation information is sent to the meeting proponent, or if the meeting time or meeting place is changed and proposed again, the changed meeting information is sent back to the meeting proponent. The meeting confirmation information or changed meeting information entered by the meeting party is stored in the meeting database.

Here, if the meeting party to the meeting is a member of the social networking service, steps 1 through 4 above are delivered via e-mail and member notification, and if the other party to the meeting is not a member of the social network service, steps 1 through 4 above are delivered via e-mail.

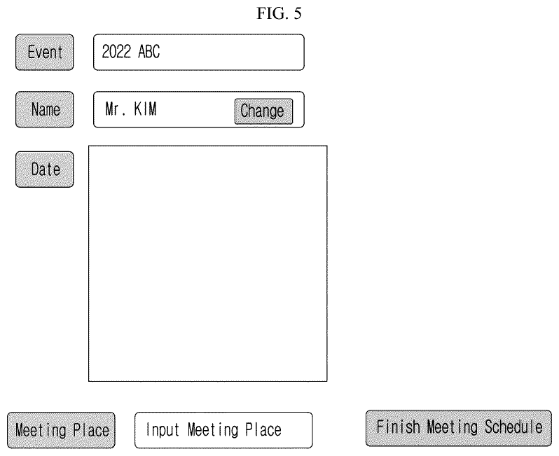

Meanwhile, in the step of outputting meeting information (S9), a list of the latest meeting information stored in the meeting information database is outputted on the meeting list screen. FIG. 5 is a schematic diagram illustrating a meeting list screen. As shown in the figure, a meeting proponent can propose a meeting to multiple meeting parties and check the latest confirmed meeting information by listing them.

The scope of the present disclosure is not limited to the embodiments described above, but may be embodied in various forms within the scope of the appended patent claims. The various modifications that would be made by one of ordinary skill in the art to which the invention belongs, without departing from the essential features of the invention as claimed in the patent claims, are deemed to be within the scope of the claimed description.

1. A method for scheduling mutual meetings, including members and non-members, on a social networking service implemented on a web, the method comprising:
a meeting proposal preparation step wherein a meeting proponent enters meeting proposal information on a meeting proposal screen, the meeting proposal information including at least one of meeting party, meeting party's company, meeting time, meeting place, and meeting party's e-mail address;
a meeting schedule preparation step preparing a meeting schedule screen for outputting the meeting proposal information or inputting new information for the meeting proposal information;
a meeting information database preparation step storing the meeting proposal screen or inputted value inputted through the meeting schedule screen in meeting information database;
a first action step transmitting a link of the meeting schedule screen to meeting party for scheduling a meeting;
a second action step storing meeting information inputted by the meeting party through information shown on the meeting proposal screen accessed through the link transmitted through the first action step;
a third action step transmitting a link of the meeting schedule screen including the inputted meeting proposal information in the meeting proposal preparation step; and
a fourth action step storing meeting confirmation information or meeting change information in the meeting information database, the meeting confirmation information of the meeting change information inputted by the meeting party accessed through the link transmitted through the third action step,
wherein if the meeting party is a member of the social networking service, processes any one of the first action step, the second action step, the third action step, and the fourth action step through member notification and e-mail, and
wherein if the meeting party is not a member of the social networking service, processes any one of the first action step, the second action step, the third action step, and the fourth action step through e-mail.

2. The method of claim 1, further comprising a member verification step to verify whether the meeting party is a member or a non-member of the social networking service based on information inputted by the meeting party before the meeting proposal preparation step and preparing a member meeting proposal screen and a non-member meeting proposal screen according to the member confirmation step.

3. The method of claim 2, further comprising a meeting information output step outputting meeting information from the database storing the meeting information.
